(19) United States
(12) Patent Application Publication
(10) Pub. No.: US 2016/0215866 A1
(43) Pub. Date: Jul. 28, 2016

(54) SPROCKET

(71) Applicant: MXC GMBH, Waging a. See (DE)

(72) Inventors: BLANK Stefan, Waging a. See (DE); BAUER Thomas, Enzersdorf 7 (DE)

(21) Appl. No.: 14/901,045

(22) PCT Filed: Jul. 4, 2014
(86) PCT No.: PCT/DE2014/000337

§ 371 Date: Apr. 8, 2016

(30) Foreign Application Priority Data
Jul. 8, 2013 (DE) 10 2013 011 355.5

(51) Int. Cl. F16H 55/12; F16H 55/30; B62M 9/00

(52) U.S. Cl. CPC F16H 55/12; B62M 9/00; F16H 55/30

(57) ABSTRACT

The invention relates to a multi-part sprocket (1), in which a hub flange (2) for securing the multi-part sprocket (1) comprising holes (6) to a wheel hub, said holes lying on a common pitch circle. Said hub flange (2) comprises an outer winding (12) for receiving a sprocket wheel (3) on the periphery (9) thereof and the sprocket wheel (3) comprises an inner winding (13), through which the hub flange (2) and sprocket wheel (3) are interconnected axially and radially.

The present invention relates to a sprocket for transmission of a torque in a gear, whose peripheral gear teeth interact in a form-fitting manner with a traction means, in particular for motorcycles.

The field of application of the present invention extends principally to traction drives. A power transmission thereby results due to at least one pairing of gear/traction means. A bolt chain or the like preferably can be used as the traction means.

U.S. Pat. No. 3,225,616 A discloses a gear, in which a plurality of overlapping tooth segments are fastened to a flange of a support wheel by means of pins and screws.

A sprocket, which is composed of a middle portion of a light metal alloy, with which a sprocket wheel made of an iron alloy is joined by rivets, is shown and described in DE 60305206 T2. For this purpose, the sprocket wheel made of an iron alloy has radial projections that correspond to pocket-like recesses in the middle portion and these projections overlap crosswise over the bottom of the pocket-like recesses.

A multi-part sprocket with an inner ring is known from US 2007/173364 A1, wherein through-holes are provided for the fastening of the sprocket onto a wheel hub, and these through-holes lie on a common pitch circle. Further, the subject described therein has a sprocket wheel with a specified period for the chain divisions.

Additionally, a two-part sprocket that provides a hub flange with which it can be mounted on the hub of a motorcycle is known from US 2003/0199351 A1. An annular sprocket wheel is attached to the hub flange by means of bolts. The hub flange and the sprocket wheel can be composed of different materials.

A disadvantage of these types of systems is that the known connections unfavorably affect the weight (mass) and that the connections with the bearing portion are for the most part not suitable for transmission of high torques under unfavorable marginal conditions. Unfavorable marginal conditions shall be understood here, for example, as motocross and endurance rides, thus rides in rough terrain and particularly in sand and mud. Further, a replacement under competitive conditions is hardly possible.

The object that is the basis of the present invention is thus to create a sprocket for the transmission of a torque, a sprocket that can be manufactured with as little effort and expenditure as possible with the lowest weight (mass) possible despite high requirements for strength, robustness and aesthetic effect. In addition, worn-out sprockets shall be suitable for recycling.

This object is achieved by sprockets with the features of claims 1 and 3. Advantageous embodiments are found in the dependent claims.

A multi-part sprocket for transmitting torque in a gear, in which a sprocket wheel interacts via its peripheral gear teeth in form-fitting manner with a chain that has a predetermined period of chain division, and in which a hub flange has through-holes that lie on a common pitch circle, for fastening the multi-part sprocket to a wheel hub, is then advantageous if the hub flange has on its outer circumference an outer thread and the sprocket wheel thus has an inner thread corresponding therewith inside its annular contour.

In addition, for a multi-part sprocket, it is favorable if the outer and inner threads are fixed in place by means of a detachable bonding.

Further, it may be particularly advantageous if the hub flange and the sprocket wheel are joined together exclusively by a bonding.

A multi-part sprocket is further advantageous if at least the sprocket wheel has a projection as a limiting stop inside its annular contour.

Furthermore, a multi-part sprocket can be configured advantageously if the hub flange is designed for the uptake of sprocket wheels with different outer diameters and correspondingly different numbers of teeth.

It is advantageous, particularly for competitions, if the sprocket wheels can be replaced in a simple way. This would bring about a savings in time in the replacing of worn-out sprocket wheels and competitive advantages, if the gear ratios can be easily changed by exchanging the sprocket wheel.

A multi-part sprocket is also favorably configured if the number of teeth in the gear teeth of the sprocket wheel is reduced in comparison to the number of teeth predetermined by the period of chain division, in particular when the distance between teeth corresponds to double the period of chain division.

A multi-part sprocket can also be advantageous if the hub flange and the sprocket wheel are composed of different materials.

A multi-part sprocket offers a particular advantage if the hub flange made of worn-out one-part sprockets is recyclable.

The invention will be explained in more detail below with the help of exemplary embodiments and details, based on the drawings.

Here:

FIG. 1 shows a spatial view of a sprocket according to the invention;

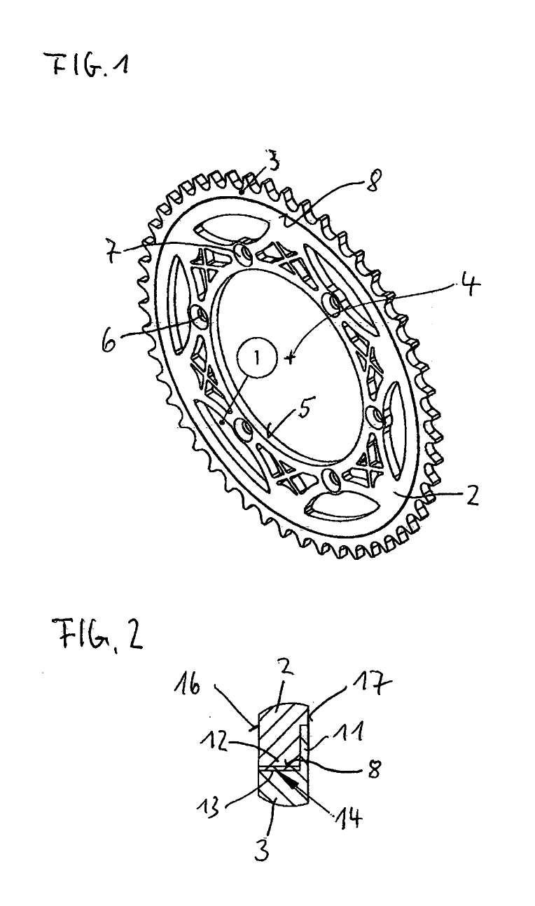

FIG. 2 shows an enlarged detail view of a connection between hub flange and sprocket wheel according to FIG. 1;

FIG. 3 shows a sprocket wheel of a sprocket according to the invention in a spatial view; and

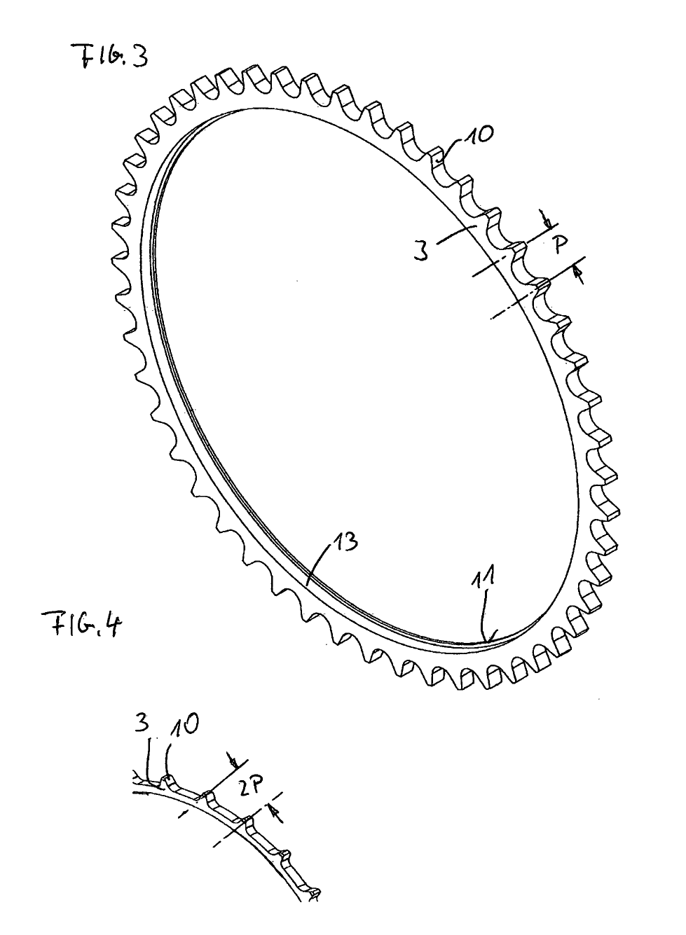

FIG. 4 shows a variant of a sprocket wheel with a reduced number of teeth.

A sprocket 1 according to the invention that is essentially composed of two main components is illustrated in FIG. 1. The first component is formed by a hub flange 2, the second by a sprocket wheel 3. The hub flange 2 has a contour that is derived from a skeletonized hexagon, so that a weight-optimized component is formed. In the center of the hub flange 2 is found an aperture 5, which provides space, for example on a motorcycle, for a wheel hub, which is not shown. Six boreholes 6 that lie on a common pitch circle are disposed concentrically relative to this aperture 5, each of the boreholes running out in a depression 7. The hub flange 2 is fastened onto the wheel hub (not shown) by means of these boreholes 6 and screws (also not shown) belonging to them. The second component representing a sprocket wheel 3, whose contour is derived from an annulus, is found on the outer circumference 8 of the hub flange 2. A gearing with a specific number of gear teeth 10 distributed uniformly over the circumference is found at the periphery 9 of the sprocket wheel 3.

As can be seen from the detail view in FIG. 2, the sprocket wheel 3 has in its inner contour a peripheral projection 11, which points radially inward. The connection between the hub flange 2 and the sprocket wheel 3 is produced via threading. In this case, the hub flange 2 bears an outer thread 12 on its outer circumference 8, and the sprocket wheel 3 bears an inner thread 13 in its inner contour, and these threads interact. The two components, hub flange 2 and sprocket wheel 3, can be securely fastened together additionally, if needed, by a bonding 14. The bonding 14 can be detachable, for example by heating.

In assembling the sprocket 1, the sprocket wheel 3 can be mounted by means of its inner thread 13 on the hub flange 2 with its outer thread 12, so that in the final position, the projection 11 directed radially inward is fitted in a recess 15 of the hub flange 2. The sprocket 1 thus has two outer surfaces 16 and 17 lying in parallel planes and is ready for operation.

However, it can also be seen from FIG. 2 that the threads can be dispensed with if a bonding 14 is provided between the inner annular contour of the sprocket wheel 3 and the periphery of the hub flange 2, this bonding fastening together these two components.

FIG. 3 shows a view of the sprocket wheel 3 of the sprocket 1 according to the invention. The inner thread 13 and the projection 11 are found in the inner contour of the sprocket wheel 3. The teeth 10 of the sprocket 1 are disposed at a distance from one another, this distance being derived from a specific chain division period P. The chain division period P is determined by the division of a link chain (not shown). The number of teeth 10 of a sprocket 1 is determined accordingly by the corresponding chain division period P in such a way that the individual chain links each engage with a tooth of a sprocket in the looping of the sprocket. The sprocket wheel 3 has continuous gear teeth; this means that--corresponding to the tooth sequence—one tooth 10 and one tooth gap are present in each division period P.

The gear teeth of the sprocket wheel 3 can also be executed in a discontinuous manner. A corresponding detail is shown in an enlarged excerpt in FIG. 4, which speaks for itself. With this type of embodiment, one tooth 10 is omitted between two teeth each time. For the given diameter of the sprocket wheel 3, in this case, clearly fewer teeth 10 are disposed on the periphery thereof. This measure—in addition to sufficient strength for the torque transmission—brings about a clear improvement of the self-cleaning of the sprocket 1 together with the chain (not shown). This effect is particularly of very great advantage for dirt bikes (motocross). The friction losses due to sand, mud and similar contaminants are also considerably reduced in comparison to a sprocket 1 with a traditional number of teeth. In competitions, this represents a clear advantage in performance.

In the exemplary embodiment shown of a sprocket 1 according to the invention, the distance between two adjacent teeth 10 is correspondingly two chain division periods 2P. Accordingly, a tooth is missing between two adjacent teeth 10, so that a tooth gap is formed, which is double the size of that in a conventional sprocket for a link or bolt chain having a specific division.

This measure is based on the knowledge that in riding a dirt bike in mud, this mud—and, of course, other contaminants also—penetrate(s) between the teeth 10 of the sprocket 1 and the links of the bolt chain and considerably adversely affect(s) the power transmission. This leads to high friction losses, to reductions in the direct contact between sprocket 1 and bolt chain, in fact to extensions of the bolt chain, which lead in turn to over-extensions and damage, but at least to premature wearing out of sprocket and bolt chain.

Due to the increase shown in the distances between two adjacent teeth 10, the contaminants and the mud are removed in a considerably better way and a certain self-cleaning occurs. It has been shown in tests that the strength necessary for the power transmission is completely assured, in addition, despite the absence of a tooth 10 in each case. An increase of the distance between two adjacent teeth to more than two chain division periods is also conceivable. The size selected for the tooth gap is determined according to the circumference of the sprocket, the division period of the bolt chain and to a certain extent also according to the power to be transmitted. Further, the additional weight reduction is also advantageous.

### LIST OF REFERENCE NUMBERS

1 Sprocket

2 Hub flange

3 Sprocket wheel

4 Center

5 Aperture

6 Borehole

7 Depression

8 Circumference

9 Periphery

10 Teeth

11 Projection

12 Outer thread

13 Inner thread

14 Bonding

15 Recess

16 Outer surface

17 Outer surface

1. A multi-part sprocket for transmission of torque in a gear, in which a sprocket wheel interacts via its peripheral gear teeth in form-fitting manner with a chain that has a predetermined chain division period, and in which a hub flange for fastening the multi-part sprocket to a wheel hub has through-holes that lie on a common pitch circle, is hereby characterized in that the hub flange (2) has an outer thread (12) on its outer circumference (8) and the sprocket wheel (3) has an inner thread (13) corresponding thereto on the inside of its annular contour.

2. The multi-part sprocket according to claim 1, further characterized in that the outer thread (12) and the inner thread (13) are fixed in place by means of a detachable bonding (14).

3. A multi-part sprocket for transmission of torque in a gear, in which a sprocket wheel interacts via its peripheral gear teeth in form-fitting manner with a chain that has a predetermined chain division period, and in which a hub flange for fastening the multi-part sprocket to a wheel hub has through-holes that lie on a common pitch circle, is hereby characterized in that the hub flange (2) is joined on its outer circumference (8) with the inside of the annular contour of the sprocket wheel (3) by means of a bonding (14).

4. The multi-part sprocket according to at least one of the preceding claims, further characterized in that at least the sprocket wheel (3) has a projection (11) as a limiting stop on the inside of its annular contour.

5. The multi-part sprocket according to at least one of the preceding claims, further characterized in that the hub flange (2) is designed for the uptake of sprocket wheels (3) with different outer diameters and correspondingly different numbers of teeth.

6. The multi-part sprocket according to at least one of the preceding claims, further characterized in that the number of teeth (10) of the gearing of the sprocket wheel (3) is reduced compared with the number of teeth (10) predetermined by the chain division period (P).

7. The multi-part sprocket according to claim 6, further characterized in that the distance between the teeth (10) corresponds to double the chain division period (2P) of the chain division (P).

8. The multi-part sprocket according to at least one of the preceding claims, further characterized in that the hub flange (2) and the sprocket wheel (3) can be composed of different materials.

9. The multi-part sprocket according to at least one of the preceding claims, further characterized in that the hub flange (2) made of worn-out single-part sprockets is recyclable.
